(19) United States
(12) Patent Application Publication
(10) Pub. No.: US 2013/0128559 A1
(43) Pub. Date: May 23, 2013

(54) Sanitary Installation

(71) Applicants: Michael Glanz, Langenfeld (DE); Bernd Brieseck, Plettenberg (DE); Siegfried Lange, Meissen (DE)

(72) Inventors: Michael Glanz, Langenfeld (DE); Bernd Brieseck, Plettenberg (DE); Siegfried Lange, Meissen (DE)

(73) Assignee: DORMA GmbH+Co.KG, Ennepetal (DE)

(21) Appl. No.: 13/696,733

(22) PCT Filed: Apr. 20, 2011
(86) PCT No.: PCT/EP2011/002009

§ 371 Date: Dec. 14, 2012

(30) Foreign Application Priority Data
May 7, 2010 (DE) 10 2010 019 916.8

(51) Int. Cl. F21S 4/00

(52) U.S. Cl. CPC F21S 4/00
USPC 362/147; 362/145

(57) ABSTRACT

The present invention relates to a sanitary installation (1) including at least one partition element (10), such as a wall or a door, said partition element (10) forming at least one part of a toilet cubicle.

According to the invention, it is intended that the partition element (10) be configured to be self-luminous and emits light (11) over at least one partition element surface (12).

The present invention relates to a sanitary installation including at least one partition element, such as a wall or a door, such partition element forming at least one part of a toilet cubicle.

### STATE-OF-THE-ART

Sanitary installations of known construction type have partition elements, by means of which individual toilet cubicles can be formed. For example, equally distanced partition elements will form a plurality of individual toilet cubicles, which have respectively one door at the front end, which is likewise considered as a partition element within the scope of the present invention. The door may be configured as a swing leaf door or as a sliding door, wherein more modern sanitary installations may even have electrically operable doors.

Separating a portion of a sanitary room for forming at least one toilet cubicle by partition elements results in unfavourable lighting conditions. In order to provide for sufficient illumination of the toilet cubicle, as a rule separate light sources are provided for each individual toilet cubicle. Said light sources may be recessed in the ceiling of the room and have a position which allows for separately radiate light into each toilet cubicle. However, in this case, the light source disposed in the ceiling may be unfavourable for using the toilet.

For sufficiently illuminating toilet cubicles, very often more light sources are required, in order to illuminate the area of the sanitary room in front of the toilet cubicles.

Therefore, it is the object of the present invention to provide a sanitary installation with partition elements for creating at least one toilet cubicle, which has improved light conditions. It is in particular the object of the present invention to provide a sanitary installation having an advantageous disposition of light sources.

This problem is solved based on a sanitary installation according to the generic part of claim 1 in conjunction with the characterizing features. Advantageous further developments of the invention are indicated in the dependent claims.

### DISCLOSURE OF THE INVENTION

The invention includes the technical teaching that the partition element is configured to be self-luminous and emits light over at least one partition element surface.

The invention is based in this case on the idea that the sanitary installation is self-illuminated via the partition element. The partition elements are configured as a pane and in consequence they have two partition element surfaces. Consequently, the partition element may emit light over one partition element surface or over both opposite partition element surfaces.

Preferably, at least one lighting means is provided, which radiates light into the at least one partition element. The partition element thereby fulfils the function of a light guide. In this case, the light guide is configured as an illuminated surface light guide, wherein, however, the light exits the light guide, preferably with homogenous intensity, over a length along which the light is guided in the light guide. By emitting light over the at least one partition element surface, it is possible to illuminate the toilet cubicle on the inside, wherein preferably the partition elements emit exclusively or additionally light over the partition element surfaces, which point to the outside, i.e. in the direction of the sanitary room itself. In consequence, the advantage is achieved that, for illuminating the sanitary installation, no additional lamps need to be installed for example in the ceiling above the toilet cubicles. Independently from the illumination of the room or of the toilet cubicle, it is thus possible to create an advantageous ambiance in the room.

The at least one lighting means may be a filament lamp, an LED, an OLED, a fluorescent-screen tube, and/or a cold-cathode tube, wherein the lighting means emits in particular coloured light. The lighting means may be configured for example as a semiconductor light source, which, by means of a colour control unit, is able to emit light in any possible colour. Thus, in addition to the proper lighting function, different lighting ambiances can be advantageously created in the sanitary installation.

Furthermore, the partition element may advantageously have means, which create a homogenous light emission over at least one partition element surface. The partition element may consist, at least partially, of glass material or a transparent plastic material, which material includes imperfections, which are incorporated into and/or onto said material; and light ejection can be preferably achieved in a homogenous or structured manner via said imperfections and over at least one partition element surface. The imperfections may constitute means, which are able to create homogenous light emission over at least one partition element surface. If the imperfections are incorporated into the partition element in a structured manner, this may have the effect that the light as well exits the partition element over the partition element surface in a structured manner, for example with a brightness structure. If imperfections are incorporated into the material, the incorporation may be achieved for example by inside laser engraving or else inclusions, which create a refraction of the light, may be provided in the material of the thus configured diffusing screen. If the light is refracted at the imperfections, it may leave the partition element at the location of the imperfection or in the area of the imperfection. The density of the imperfections or the type, in particular the size of the imperfections, may be provided such that, based on the arrangement of the lighting means, a change of the imperfections may result in a homogenous light emission over the surface of the partition element. The density of the imperfections may for example increase with increasing distance from the location of light radiation into the partition element. As a result, homogenous light emission over the entire partition element surface may be achieved, without creating differences in luminosity. The imperfections may be likewise present on the surface of the partition element, and be realized by imprint of ceramic baked enamel, by etching a raster, by sandblasting or by scratching the surface. The partition element may comprise several layers like a sandwich, which, in addition, may consist of different materials. Consequently, one layer may fulfil the function of a diffusing screen, into which the imperfections are incorporated or the imperfections are affixed onto the surface thereof.

The partition element may include a light distributing body, to which a transparent body is affixed on one flat side and preferably on both flat sides of the light distributing body. A diffuser film and/or reflector film may be disposed between the light distributing body and the at least one transparent body. Said film assumes in this case the diffusion of the injected light and ensures a preferably homogenous ejection of the light over the partition element surface. The diffuser film and/or reflector film may have for example a surface with a prism structure, which causes the light, injected into the light distributing body, to enter the film and, on account of the prism structure, to be deflected in such a way that the principle of total light reflection is invalidated at the surface of the light distributing body. If, on account of the prism deflection, an angle limit between the light beam and the surface of the light distributing body falls short, the result is light ejection. Consequently, the prism structure may have a variation over the flat extension of the diffuser film and/or reflector film, which variation is determined such as to achieve a homogenous light ejection over the entire surface of the partition element.

Advantageously, the at least one partition element may have edges delimiting the flat extension, wherein the light is injected into the partition element via at least one edge. In this case, at least one other edge may be surrounded and/or rimmed by an edge element. Said edge element may be mirror-coated in the direction of the partition element, in order to reflect the light back into the partition element, which light exits the partition element via the other edge. The partition element may be configured for example as a door, such that the lighting means is disposed at the edge of the door where the door hinges are likewise installed. Obviously, the lighting means may be disposed as well at all four edges of a partition element.

Advantageously, the at least one lighting means is disposed in the edge element and/or between the edge element and the edge of the partition element such as to be invisible from the outside. The edge elements may have a U-shaped profile, such that the edge of the partition element is surrounded by the edge element. A hollow space, created between the edge element and the edge of the partition element, may serve for accommodating the lighting means. The lighting means is thus disposed in the edge element or between the edge element and the partition element such as to be invisible from the outside.

According to another possible embodiment, the partition element may have two panes of glass material or of a plastic material, which, with a surface light emitting body disposed between the panes, constitute a sandwich arrangement. The surface light emitting body may comprise lighting means which are disposed on the flat extension of the surface light emitting body. Preferably said lighting means may consist of semi-conductor lighting means, such as LEDs or OLEDs. In this case, light radiates through at least one pane which light emanates in a flat manner from the surface light emitting body. The surface light emitting body may emit light from one side or from both sides, wherein advantageously the pane of the light emitting side acts as a diffuser pane. The diffuser pane may consist of milk glass or a cloudy plastic material, in order to achieve a homogenous effect on the light which is emitted by the LEDs in the surface light emitting body. If the surface light emitting body has OLEDs, they already serve as a surface emitter so homogenization of the emitted light by a diffuser effect of the pane is not necessarily required, may however be intended in addition.

The surface light emitting body does not necessarily have to be disposed between two panes in a sandwich arrangement and may instead form a border body of the partition element. The surface light emitting body may emit light for example over its surface which forms at the same time the exterior surface of the partition element. Advantageously, the surface light emitting body may have a cover pane on a light emission side, which pane consists of the aforementioned glass material or of plastic material.

According to another possible embodiment, the at least one partition element has a closing device, wherein the closing device cooperates with the at least one lighting means. The operative connection may be configured as an electrical connection, wherein, with particular advantage, in addition to the proper closing function and opening function of the door, the closing device serves as an electrical switch.

The operative connection between the closing device and the at least one lighting means may be configured such that, depending on the closing condition of the closing device, the lighting means can be switched on and off and/or controlled in the emitted light colour. A toilet cubicle for example which is occupied may indicate the occupied condition via the light emission of at least one partition element. If a toilet cubicle is occupied, the closing device is locked. If the closing device is locked, the occupied condition of the toilet cubicle can be indicated via the operative connection between the closing device and at least one lighting means, in that at least one partition element emits light. Another possible embodiment is provided in that the light colour, which is emitted over at least one partition element of an associated toilet cubicle, indicates the occupied condition. If the closing device is locked, the partition element of the toilet cubicle in question may emit red light for example. If a toilet cubicle is not occupied, and the closing device is consequently not locked, a partition element, associated to a toilet cubicle, may emit for example green light. Consequently, by the light signal emitted by means of the partition elements, a viewer clearly recognizes advantageously already at a greater distance from the sanitary installation, which toilet cubicle among a plurality of toilet cubicles is occupied or free.

With particular advantage, the partition element may be configured to be transparent in such a way that, with the lighting means not switched on and with the partition element not emitting light, the partition element is transparent. Once the lighting means are switched on and the partition element emits light, the translucent property of the partition element can be changed by a diffusing effect occurring in the partition element. If a toilet cubicle is for example occupied and the lighting means are activated via the closing device, the translucency changes and the partition elements are no longer transparent. Consequently, a user of a toilet cubicle may activate the closing device of the door such that it is impossible to look into the toilet cubicle in the occupied condition. A similar effect can thereby be achieved like with the already known toilet cubicles in which the translucency can be changed via polarisation filters.

Furthermore, the partition wall elements may be configured as back ground illumination for pictures or advertising signs, which are provided on the light emitting surface with pictures or graphics made of semi-transparent films.

The problem of the present invention is furthermore solved by a partition element which constitutes at least one part of a toilet cubicle of a sanitary installation, wherein said partition element is configured at least as one wall or one door of the toilet cubicle. It is intended in this case, that the partition element is configured to be self-luminous and emits the light over at least one partition element surface.

### PREFERRED EMBODIMENTS

Hereinafter, further measures enhancing the invention will be illustrated in more detail in conjunction with the description of preferred embodiments of the invention based on the Figures. In a diagrammatic illustration

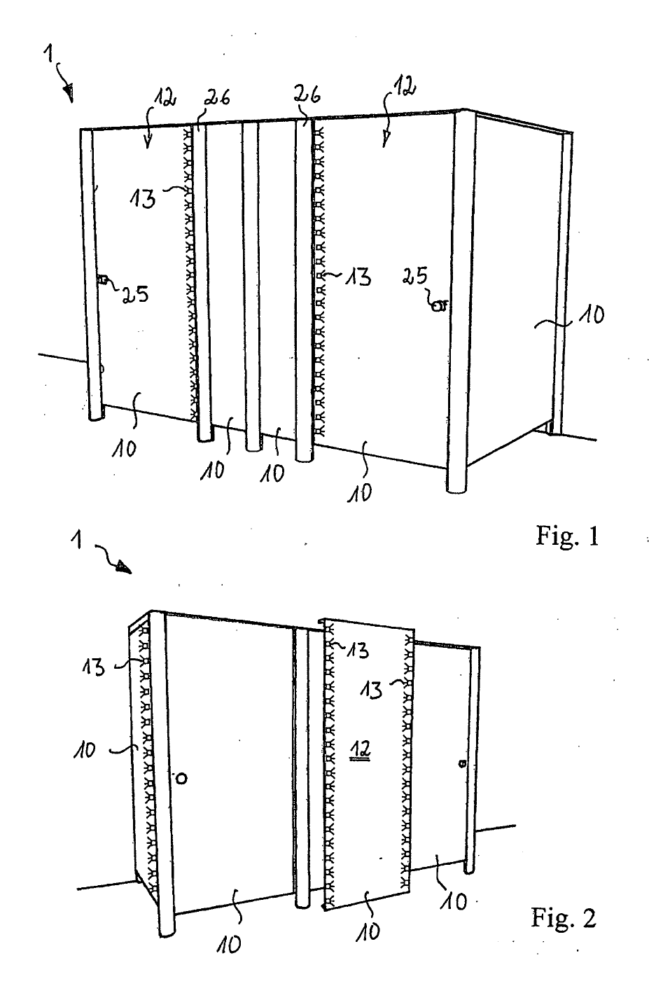

FIG. 1 shows an embodiment of a sanitary installation with partition elements according to the present invention, which are configured as swing leaf doors,

FIG. 2 shows another embodiment of a sanitary installation with partition elements according to the present invention,

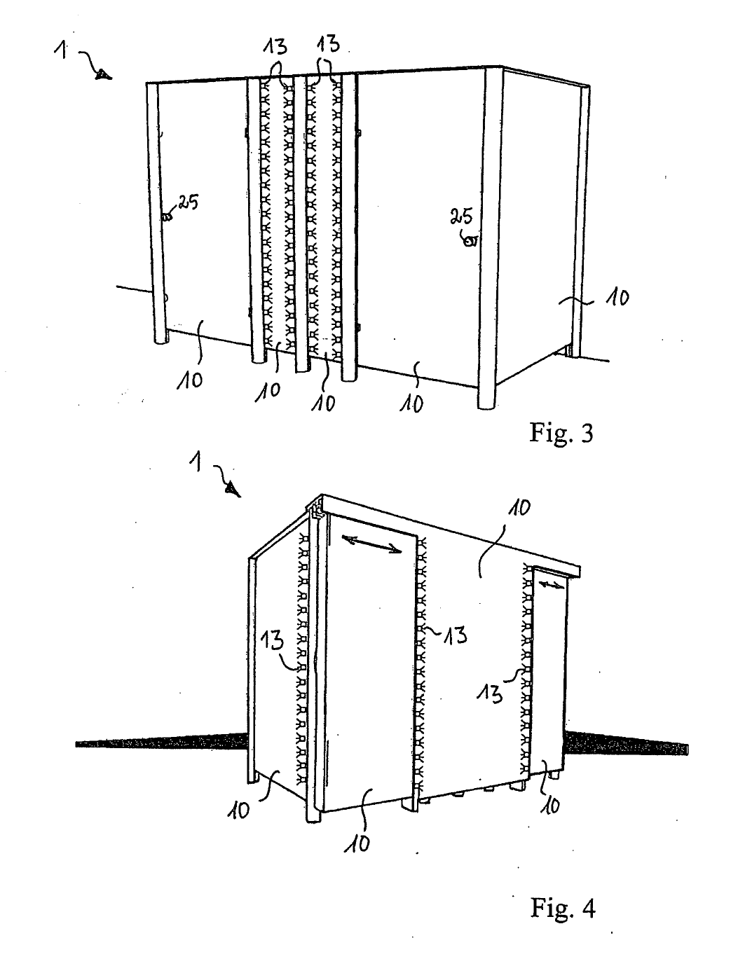

FIG. 3 shows another embodiment of a sanitary installation with partition elements according to the present invention, which are configured as rigid wall elements,

FIG. 4 shows another embodiment of a sanitary installation with partition elements according to the present invention, wherein partition elements form doors, which are configured as sliding doors,

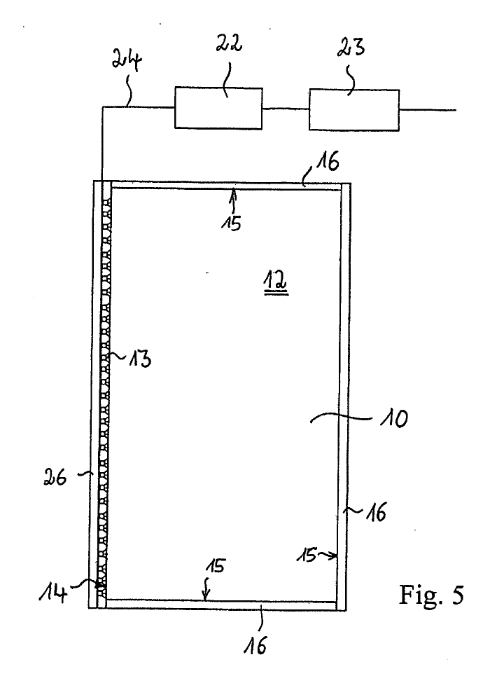

FIG. 5 shows the illustration of a partition element with an electrical control for lighting means,

FIG. 6 shows a possible embodiment of a partition element, which includes a light distributing body,

FIG. 7 shows another embodiment of a partition element with a light distributing body and transparent bodies disposed like a sandwich,

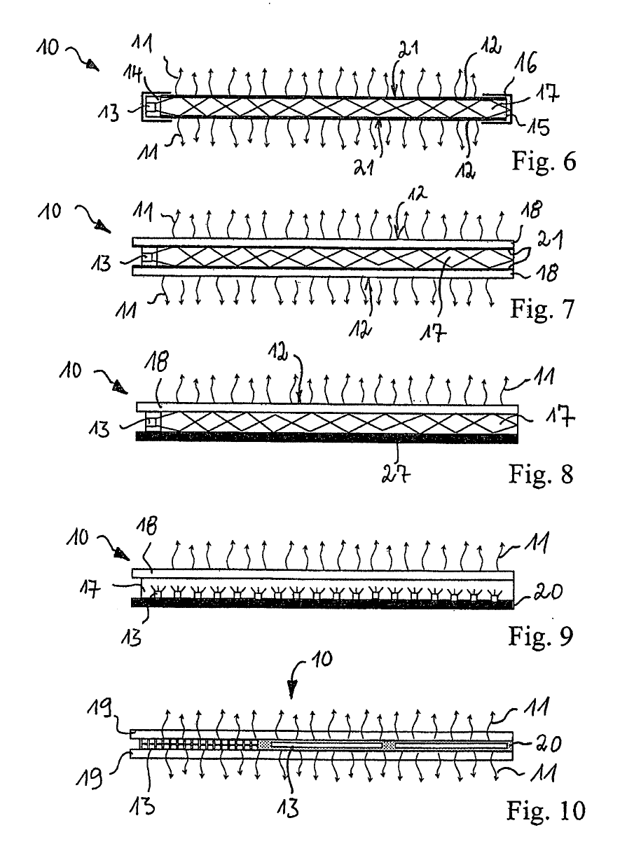

FIG. 8 shows another embodiment of a partition element with unilateral emission of light,

FIG. 9 shows another embodiment of a partition element with a surface light emitting body,

FIG. 10 shows another embodiment of a partition element with a surface light emitting body, which is disposed like a sandwich between two panes.

Different embodiments of sanitary installations 1 according to the present invention are shown in FIGS. 1, 2, 3 and 4. The sanitary installations 1 are configured with several partition elements 10, which, according to the embodiments, form sanitary installations 1 with respectively two toilet cubicles. The partition elements 10 are configured as exterior walls, as intermediate walls or as doors for the toilet cubicles. According to the present invention, the partition elements 10 are configured as self-luminous partition elements 10, which emit light 11 over the partition element surfaces 12, in a way not shown in detail. The partition element surfaces 12 represent in this case the plane surfaces of the partition elements 10, wherein the emission of light 11 may be realized both over the partition element surface 12 which points towards the exterior side of the toilet cubicle, and over the partition element surface 12 which points towards the inside of the toilet cubicle. A simple and in particular advantageous illumination of the sanitary installation 1 is thereby created, which advantageously may replace further lighting means for illuminating the sanitary room.

FIG. 1 shows a sanitary installation 1 with two toilet cubicles which has partition elements 10 at the exterior sides and partition elements 10 configured to be narrower towards the front side. The partition elements 10 pointing towards the front side extend together with further partition elements 10 in one plane, and constitute the doors of the toilet cubicles. The partition elements 10, forming the doors, are disposed to be pivotable at the hinge posts by means of door hinges. According to the invention, the partition elements 10, executed as doors, are configured as self-luminous partition elements 10 and emit light at least over one of its partition element surfaces 12. For this purpose, the partition elements 10 have lighting means 13, which are configured as LED-lighting means and are disposed like a lighting strip in the area of the hinge post 26. The lighting means 13 emit light into the partition elements 10 configured as doors, so they are self-luminous.

The partition elements 10 which form the doors, have closing devices 25 in order to latch and unlatch the doors. In a way, which is not illustrated in detail, the closing devices 25 are connected to a colour control unit, which allows the lighting means 13 to emit light in different colours. The colour of the light, which is radiated into the partition elements 10 via the lighting means 13 and is emitted over the partition element surfaces 12 to at least one side of the partition element 10, may be controlled depending on the closing condition of the closing device 25. A partition element 10 for forming a door may for example emit green light, if the closing device 25 is not closed. If the closing device 25 is being closed, the operative connection between the closing device 25 and the colour control unit effects a change in colour such that a partition element 10 for forming a door, which is closed, emits red light. As a result, in addition to the illumination function of the sanitary installation 1, a signal function is fulfilled, which provides information to a user about whether or not a toilet cubicle is occupied.

FIG. 2 shows another embodiment of a sanitary installation 1 with several partition elements 10 for forming two toilet cubicles. The partition elements 10, shown at the front end, are configured as swing leaf doors, wherein another partition element 10 is provided between the partition elements 10 which form the swing leaf doors. The embodiment shows the partition element 10 in the middle likewise as self-luminous partition element 10, which is able to emanate light both over the partition element surface 12 located in front of the sanitary installation and in the direction of the toilet cubicles. At the same time, the self-luminous partition element 10 in the middle may serve as the carrier element for advertising media. Said advertising media may be installed or stentered in front of the partition element. The partition element 10 itself, located between the partition elements 10 which form the doors, may itself serve as the advertising medium. The partition element 10 in the middle for example may be manufactured from plastic material which fulfils the function of a light guide and is simultaneously illuminated by an advertising graphic. On two vertically extending opposite edges, the partition element 10 in the middle has a row of lighting means 13, which again by way of example are configured as LED-lighting means 13. Furthermore, a laterally present partition element 10 is shown to be configured with lighting means 13, such that this partition element 10 is likewise self-luminous.

FIG. 3 shows a further embodiment of a sanitary installation 1 with two toilet cubicles, which are formed by partition elements 10 as lateral walls and by partition elements 10 configured as swing leaf doors. Furthermore, partition elements 10 are shown, which form the toilet cubicles and are located between the doors, and they are configured as self-luminous partition elements 10. The self-luminous partition elements 10, via opposite edges, have respectively a row of lighting means 13, which may be designated as lighting strips. If the partition elements 10 emit light to both the outside and to the inside in the direction of the toilet cubicle, it is possible to achieve illumination of both the toilet cubicle itself and the outside of the sanitary installation 1. Obviously, the lighting means 13 may be coupled again to the closing devices 25 and, depending on the closing condition of the closing devices 25, the lighting means may be switched on or off or emit a corresponding light colour. The partition element 10, which points to the respective side of the toilet cubicle, may for example emit a red or a green light, in order to indicate to a user, whether or not the toilet cubicle is occupied.

FIG. 4 shows another embodiment of a sanitary installation 1 with partition elements 10, which are embodied as sliding doors. Another partition element 10, which is equipped with lighting means 13, is located between the partition elements 10 configured as sliding doors and consequently represents a self-luminous partition element 10. The lateral walls are likewise illustrated as partition elements 10 in a self-luminous embodiment, which again have lighting means 13.

In a diagrammatic view, FIG. 5 shows a partition element 10 with a number of lighting means 13, which are disposed at the edge 14 of the partition element 10, which edge borders a hinge post 26. A gap, in which the lighting means 13 are accommodated, is left between the edge 14 of the partition element 10 and the hinge post 26. The lighting means 13 may directly radiate into the body of the partition element 10, such that, according to the principle of total reflection, initially the light expands in the partition element 10 itself. In order to prevent the light from exiting beyond the rest of the edges 15, edge elements 16 are provided which cover the rest of the edge elements 15. The edge elements 16 may be configured to be mirror-coated at least on the inside, in order to reflect exiting light back into the partition element 10. By means of imperfections, surface structures or diffuser film and/or reflector films laminated onto the partition element surfaces, neither of them is illustrated in detail, it is achieved that the light leaves the partition element 10 via the partition element surfaces 12 so that the partition element 10 becomes a surface emitter. A power supply unit 23 supplies electric energy to the lighting means 13, wherein a colour control unit 22 is shown which directly controls the lighting means 13 in such a way that their light colour is changeable. The lighting means 13 may be configured as RGB-light emitting diodes, which, by additive colour mixture of blue, green, and red light, are able to emit any optional light colour. A colour can thus be predetermined by means of the colour control unit 22 or the colour control unit 22 ensures a constant change of the light colour, which the lighting means 13 emits, in order to create for example certain room ambiances. In particular the lighting means 13 do not all have to emit generally the same colour, instead the lighting means 13 may emit respectively a different colour such that an overlay of different light colours occurs in the partition element 10 itself. The electrical connection between the colour control unit 22 and the partition element 10 is effected via an electrical supply line 24 which may be advantageously incorporated into the hinge post 26.

FIG. 6 shows an embodiment of a partition element 10 which is configured as a simple light distributing body 17. A lighting means 13 is shown on an edge 14 of the light distributing body 17. The lighting means 13 emits light 11 into the light distributing body 17. At least a partially total reflection at the partition element surfaces results in an essentially homogenous illumination of the light distributing body 17. An edge element 16 is shown on the edge 15 of the light distributing body 17 opposite the disposition of the lighting means 13, and a back-reflection of light occurs by said element in that the light is emitted via the edge 15 and, via the edge element 16, it is injected back into the light distributing body 17. The partition element surfaces 12 are provided with a surface structure which allows for a homogenous ejection of light 11. The surface structure may vary with increasing distance to the arranged lighting means 13 such that the ejection of light 11 close to the arranged lighting means 13 is realized with the same intensity as with an increased distance to the lighting means 13. The surface structure may be a roughened surface of the light distributing body 17, or diffuser films and/or reflector films 21 are bonded to the partition element surfaces 12.

FIG. 7 shows another embodiment of a partition element 10 with a light distributing body 17 and an arrangement of lighting means 13, which radiates light into the light distributing body 17 which emanates light homogenously over the partition element surfaces 12. The partition element 10 is configured like a sandwich, wherein initially diffuser films and/or reflector films 21 are affixed to the surfaces of the light distributing body 17, wherein the exterior surfaces are constituted by transparent bodies 18. Said bodies are transparent for the light which exits over the surface of the light distributing body 17. The diffuser films and/or reflector films 21 may have an opaque, mat structure such that the partition element 10 is not even then transparent if the lighting means 13 do not emit light 11.

FIG. 8 shows another embodiment of a partition element 10 which emits light 11 to just one side. The lighting means 13 radiates light into the light distributing body 17, which has a non-transparent body 27 on a first surface illustrated to be on the bottom side, whereas a transparent body 18 is affixed to the opposite surface of the light distributing body 17, illustrated to be on the top side. The light 11, which radiates into the light distributing body 17 via the lighting means 13, leaves the body only over the partition element surface 12 which is formed by the transparent body 18. The surface of the non-transparent body 27, pointing in the direction of the light distributing body 17, may include mirror-coating in order to possibly maximize the portion of light 11, which is emitted over the upper partition element surface 12.

FIG. 9 shows another embodiment of a partition element 10 with a light distributing body 17, which is made for example from a glass element or from a transparent plastic material. The surface light emitting body 20 is disposed on the lower surface of the light distributing body 17, whereas again a transparent body 18 is shown on the top side. A plurality of lighting means 13, which respectively emit light 11, are disposed on the surface light emitting body 20. The lighting means 13 may be disposed like a matrix over the surface of the surface light emitting body 20, wherein the transparent body 18 may act as light-diffuser in such a way that the lighting means 13 can not be noticed as individual light sources.

FIG. 10 shows another embodiment of a partition element 10 which comprises again a surface light emitting body. This body may include both lighting means 13 in the shape of LEDs or lighting means 13 in the shape of OLEDs, namely surface emitters. On both sides, the surface light emitting body 20 is provided with panes 19, which again may produce a light homogenizing effect. The lighting means 13, for example in the shape of LEDs or OLEDs may be disposed across the extension plane of the partition element 10 in such a way that in particular colour graphic designs are generated.

The present invention in its configuration is not limited to the above presented preferred embodiments. On the contrary, a number of variants is conceivable, which make use of the illustrated solutions, even with basically different types of embodiments. All features and/or advantages including constructional details, spatial dispositions and method steps, which result from the claims, the description or the drawings, may be essential to the invention, both by themselves and in their most various combinations.

### LIST OF REFERENCE NUMERALS

1 sanitary installation

10 partition element

11 light

12 partition element surface

13 lighting means

14 edge

15 edge

16 edge element

17 light distributing body

18 transparent body

19 pane

20 surface light emitting body

21 diffuser film and/or reflector film

22 colour control unit

23 power supply unit

24 electrical supply line

25 closing device

26 hinge post

27 non-transparent body

1.-16. (canceled)

17. A sanitary installation comprising:
at least one partition element, configured as at least one of a wall and a door, the at least one partition element forming at least one part of a toilet cubicle,
wherein the at least one partition element is configured to be self-luminous and emits light over at least one partition element surface.

18. The sanitary installation according to claim 17, further comprising at least one lighting element that radiates light into the at least one partition element.

19. The sanitary installation according to claim 18,
wherein the at least one partition element is a light guide.

20. The sanitary installation according to one of the claim 18,
wherein the at least one partition element further comprising a homogenous light emission element arranged on at least part of the at least one partition element surface.

21. The sanitary installation according to claim 18,
wherein the at least one partition element is at least partially at least one of a glass material and a transparent plastic material,
wherein the at least one of the glass material and the transparent plastic material comprises imperfections that provide light ejection preferably over the at least one partition element surface.

22. The sanitary installation according to claim 18,
wherein the at least one partition element further comprises at least one edge that delimits a flat extension of the at least one partition element, wherein the light is radiated into the at least one partition element via the at least one edge.

23. The sanitary installation according to claim 22, further comprising one more edge that is at least one of surrounded by and bordered by an edge element.

24. The sanitary installation according to claim 23,
wherein the at least one lighting element is disposed at least one of:
to be unseen from a side of the edge element opposite the at least one partition element and
between the edge element and the one more edge of the at least one partition element.

25. The sanitary installation according to claim 17,
wherein the at least one partition element is configured to emit light at least one of over a partition element surface and over both opposite partition element surfaces.

26. The sanitary installation according to claim 17, wherein the at least one partition element comprises:
a light distributing body;
at least one transparent body being affixed to the light distributing body on at least one flat side of the light distributing body.

27. The sanitary installation according to claim 26, further comprising:
at least one of a diffuser film and reflector film disposed between the light distributing body and the at least one transparent body.

28. The sanitary installation according to claim 18, wherein the at least one lighting element is one of a filament lamp, an LED, an OLED, a fluorescent-screen tube and a cold cathode tube.

29. The sanitary installation according to claim 17, wherein the at least one partition element comprises:
a first pane made from at least one of glass material and plastic material;
a second pane made from the at least one of the glass material and the plastic material; and
a surface light emitting body disposed between the first pane and the second pane in a sandwich arrangement.

30. The sanitary installation according to claim 18, wherein the at least one partition element further comprises:
a closing device that is operatively coupled with the at least one lighting element.

31. The sanitary installation according to claim 30, wherein based at least in part on a condition of the closing device at least one of:
the at least one lighting element is switched on and off and the at least one lighting element is controlled with respect to its emitted light color.

32. A partition element, configured to form at least one part of a toilet cubicle of a sanitary installation, wherein the partition element is configured as at least one of a wall and a door of the toilet cubicle,
wherein the partition element is self-luminous and emits light over at least one partition element surface.

33. The sanitary installation according to claim 18, wherein the at least one partition element is a light guide.

34. The sanitary installation according to one of the claim 33, wherein the at least one partition element further comprising:
a homogenous light emission element arranged on at least part of the at least one partition element surface.

35. The sanitary installation according to claim 21, wherein the light ejection is at least one of homogenous and structured.

36. The sanitary installation according to claim 18, wherein the at least one lighting element emits in particular colored light.
